(19) United States
(12) Patent Application Publication
(10) Pub. No.: US 2006/0267354 A1
(43) Pub. Date: Nov. 30, 2006

(54) Doorstop

(76) Inventor: Cristiaan Stefanus Lambertus Petrus Van Den Heuvel, Penetanguishene (CA)

Correspondence Address: MCCARTER & ENGLISH, LLP, FOUR GATEWAY CENTER, 100 MULBERRY STREET, NEWARK, NJ, 07102, US

(21) Appl. No.: 11/362,275

(22) Filed: Feb. 24, 2006

Related U.S. Application Data
(63) Continuation-in-part of application No. 11/141,684, filed on May 31, 2005.

(51) Int. Cl. E05C 17/04

(52) U.S. Cl. 292/262

(57) ABSTRACT

A doorstop having at least one continuous shaped stop cushion thereon, the base of which generally resembles the perimeter of the surface to which it is attached. The doorstop further contains an aperture therethrough, as well as two protrusions extending from the doorstop's lower surface to facilitate its assembly to a vehicle.

### CROSS-REFERENCE TO RELATED APPLICATIONS

The present application is a continuation-in-part of U.S. application Ser. No. 11/141,684 filed May 31, 2005, which is hereby incorporated by reference in its entirety.

### FIELD OF THE INVENTION

This invention relates to a doorstop. Doorstops are used particularly in motor vehicles. An example of a doorstop for a motor vehicle is described in U.S. Pat. No. 6,842,943 to Hoffmann et al.

### BACKGROUND OF THE INVENTION

Doorstops are commonly used in motor vehicles, and serve a number of purposes. For example, a doorstop augments the mechanism that facilitates capturing the door in the closed position. A doorstop further aids in guiding some of the travel of the door. Additionally, a doorstop may help cushion the impact of the door closing against the body of the vehicle. Further, when the cushion on the doorstop is compressed by a closed and latched door, the compressed cushion projects an outwardly directed resultant force on the door, which aids in maintaining the door rigidly secured against the body of the vehicle via the latch, thus preventing the door from rattling during travel.

### SUMMARY OF THE INVENTION

According to the invention, there is provided a doorstop having at least two cushions on an upper surface thereof. The footprints, or bases, of the cushions have the approximate shapes of the surfaces to which they are attached. Thus, they are shaped cushions. The base of a shaped cushion may generally resemble a perimeter of the surface to which it is attached.

In one embodiment, the doorstop comprises two housing parts, each of approximately trapezium shape, and each having a shaped cushion on the upper surface thereof. The doorstop further comprises a central aperture therethrough, and the shaped cushions may be positioned around the aperture on the upper surface of the doorstop.

The doorstop may also have at least two male protrusions extending in a direction away from the cushions, the protrusions being spaced apart in a direction along a longitudinal axis of the doorstop. The protrusions may be threaded or unthreaded.

The two housing parts of the doorstop may fit together with an aligning mechanism comprising two cooperative elements, such as two male/female bushings. Additionally, the two housing parts may be formed using a sonic welding process.

### BRIEF DESCRIPTION OF THE DRAWINGS

Embodiments of the invention will now be described, by way of example, with reference to the accompanying drawings in which:

FIG. 1 is a sectional side view of a doorstop from U.S. Pat. No. 6,842,943;

FIG. 2 is a top plan view of two parts of a doorstop according to one embodiment of the present invention;

FIG. 3 is a side perspective view of the two dissembled parts forming the doorstop of FIG. 2.

FIG. 4 is an interior side elevational view of one part of the doorstop taken along lines 4-4 in FIG. 3.

FIG. 5 is a perspective view of a doorstop of approximately rectangular cross-section;

FIGS. 6 and 7 illustrate other parts for use with the doorstop part of FIG. 5;

FIG. 8 is another embodiment of a doorstop;

FIG. 9 is a part for use with the doorstop of FIG. 8.

FIG. 10 is another embodiment of a doorstop;

FIG. 11 is a part for use with the doorstop of FIG. 10.

FIG. 12 is another embodiment of a doorstop;

FIG. 13 is a side perspective view of the two disassembled parts forming the doorstop of FIG. 12;

FIG. 14 is an interior side elevational view of one part of the doorstop taken along lines 14-14 in FIG. 13.

### DETAILED DESCRIPTION OF THE INVENTION

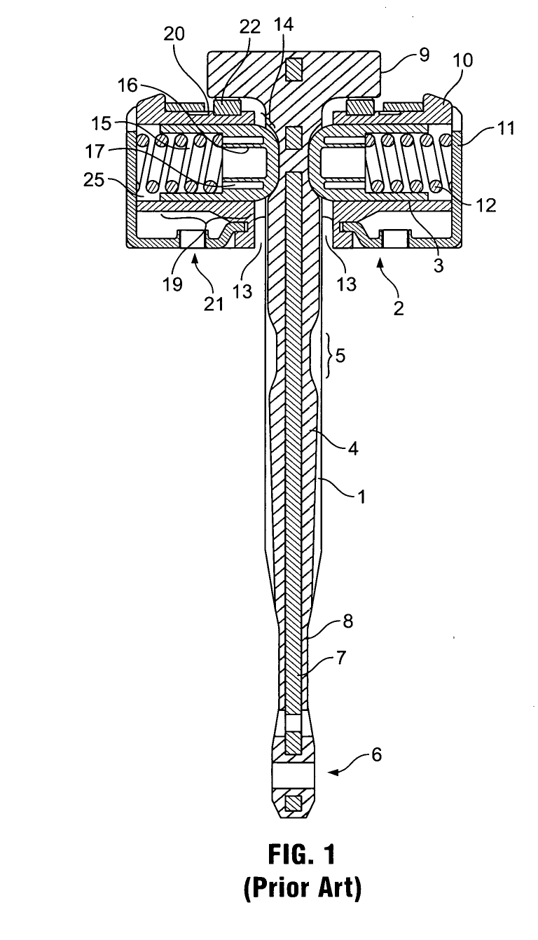

FIG. 1 shows a sectional side view of a doorstop, as illustrated in U.S. Pat. No. 6,842,943, the plane of section running through the doorstop parallel to the pivot axis and the door retaining rod 1 passing though the retaining piece 2. At its bottom end in the figure, the door-retaining rod 1 has a bearing eye 6, and at the other end an abutment 9. The door-retaining rod 1 is constructed from a metal core 7, for example a flat steel section, which is covered with plastic. The plastic covering 8 is applied with different thicknesses over the length and forms bulges in the form of local thickenings, which form the brake ramps 4 and the catch depressions 5 between the bulges. In the exemplary embodiment shown, the abutment 9, which forms the limit stop corresponding to the open position of the door, is of integral T-shaped design. The abutment 9 or the limit stop may also be alternatively formed by a pin, which is arranged through a corresponding opening in the door retaining rod 1 in the direction of the pivot axis. The brake ramps 4 and the catch depressions 5 are formed on the sides of the door-retaining rod facing the pivot axis. In the position shown, the brake and/or stop bodies 3 bear bilaterally preloaded against catch depressions. The door-retaining rod 1 is led through the opening 13 in the housing 10. The brake and/or stop bodies 3 are guided in guide openings 25 arranged perpendicular to the opening 13.

The brake and/or stop bodies 3 take the form of hollow cylinders which are sealed at one end by a semi-spherical cap 14. In their open end, they accommodate a pressure spring 12 resting on the closing cap 14, the spring being supported on a side wall of the housing 10. The end faces of the housing 10 are enclosed by U-shaped metal frames 11, which also constitute the supporting wall for the pressure springs. The brake and/or stop bodies 3 have a central bore 16 accessible from their cylindrical cavity 15 and further bores 17 arranged in a circle around this. The shape and arrangement of the bores 16 and 17 permit approximately equal wall thicknesses in the semi-spherical cap 14. The semi-spherical cap 14 is truncated at its front end. The approximately equal wall thicknesses provide an advantageous prerequisite for manufacturing the brake and/or stop bodies from plastic by the injection molding process. In its cylindrical part 19, the outer wall of the brake and/or stop bodies 3 is fluted in the direction of movement, thereby on the one hand ensuring a favorable distribution and transmission of slide lubricants, and on the other reducing the bearing surface of the cylindrical part 19 on the inner surface of the guide opening 25 and hence frictional forces occurring when the brake and/or stop bodies 3 slide in the guide opening 25.

Cushions 22 of an elastic material are integrated into the upper end surface 20 of the housing 10, against which cushions the abutment 9 resiliently strikes when the door is in the open position. Fixing apertures 21 are arranged in the bottom end surfaces of the metal frames 11. In the exemplary embodiment shown, these have an internal thread for fixing the retainer piece to a door assembly piece by means of threaded screws. Press-on screws, not shown here, can also be used for fixing, however. It will be obvious that in the embodiment of the housing 10 and metal frame 11 shown, there is a high degree of flexibility in the choice of hole spacing and hence in the hole piercing variants.

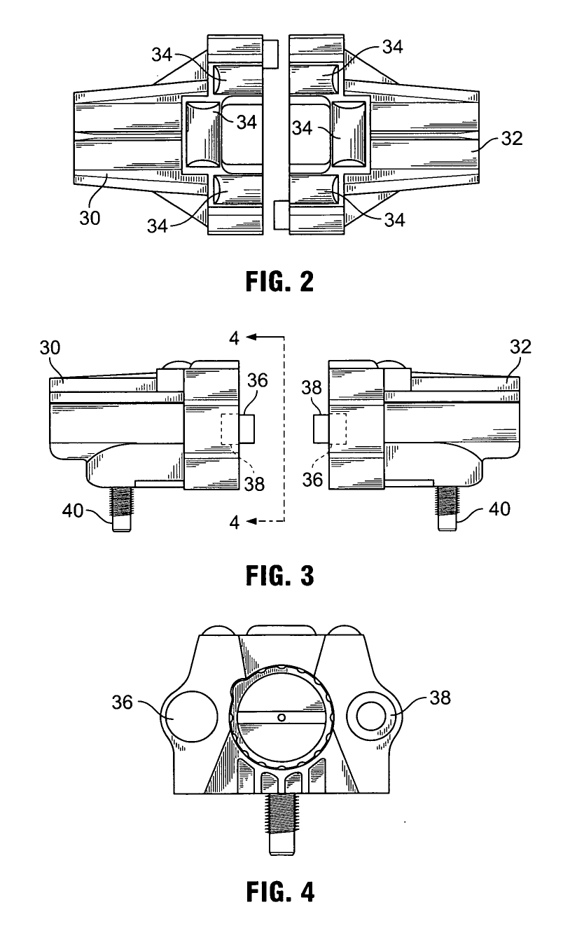

Referring to FIGS. 2, 3 and 4, the doorstop is made of two similar housing parts 30 and 32 of approximately trapezium shape in cross-section. A total of six stop cushions 34 of elastic material are integrated into the upper surfaces of the housing parts 30 and 32, three on each plastic housing part. This number of cushions 34 is a substantial non-obvious improvement over previous arrangements and permits the accommodation of more “head” configurations than previously accomplished. Even a total of four cushions 34 were found to be advantageous, although six were better. It is a cost saving as well, over putting the cushions on a link arm.

The two housing parts fit together with an aligning or “locking” mechanism comprising two round male/female bushings 36 and 38. It has been found that this tends to overcome a matching and stacking problem.

A male threaded stud 40 is provided on each housing part 30 and 32 to facilitate assembly to a vehicle by a customer.

The parts of the housing can conveniently be produced by using a sonic welding procedure. This would appear to result in a saving of costs for two rivets and should save integrity and time.

It will be understood that the frame in the housing according to the present invention is all plastic, whereas in U.S. Pat. No. 6,842,943 to Hoffmann et al., the frame 11 is a U-shaped metal frame.

In some arrangements the housing parts may be offset.

It will be understood that injection molding may be utilized, and the parts may be run on vertical or horizontal machines. It is also anticipated that multi-cavity molds may be used. Shrink and warp behavior in insert molding, due to the size of the product, is expected. Control of the process characteristics, such as mold temperatures, injection speeds and pressure, is required. Proper drying of the material is required. Co-injection and/or over molding can also be used to manufacture the product.

It will also be understood that the fabrication technology that is used, may be suitable for the formation of large, long-fiber-reinforced structural thermoplastic parts.

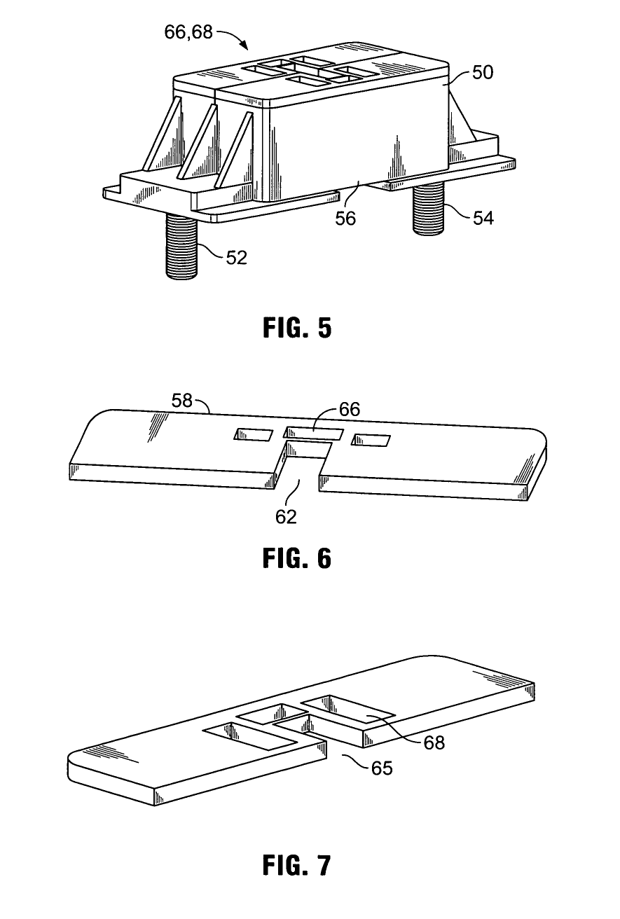

Another embodiment of the present invention is shown in FIGS. 5-7. In FIG. 5 it will be seen that the doorstop 50 is of rectangular shape in cross-section and has two studs 52 and 54 in an appropriate location. As will be appreciated, studs 52 and 54 may be threaded or un-threaded. These studs are molded in the base of doorstop 50 which has a central aperture 56 whereby a link arm assembly can be inserted.

To close the top of doorstop 50, two panels 66 and 68 (FIGS. 6 and 7) are used. These are each of a dimension to cover half the top of doorstop 50 and close the top apart from rectangular apertures 62 and 64. The two half panels 66 and 68 are molded with cushions, i.e. bumpers, and when completed by either heat or electrosonic “staking”, will form an enclosed top as in FIG. 5.

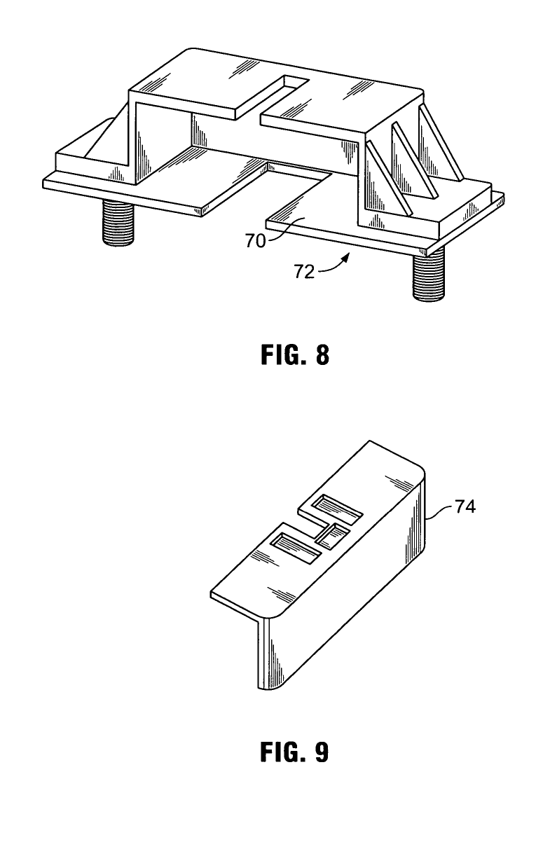

FIG. 8 illustrates a further embodiment in which the side 70 of the rectangular doorstop 72 is open. Again, two studs are molded into place.

The side is closed by a right-angle shaped molded plastic part, as in FIG. 9, with over-molded soft rubber “bumpers” on the sides of the angle-shaped plastic parts. It is assembled by means of either heat staking or ultra-sonic welding to the rectanguloid part 72.

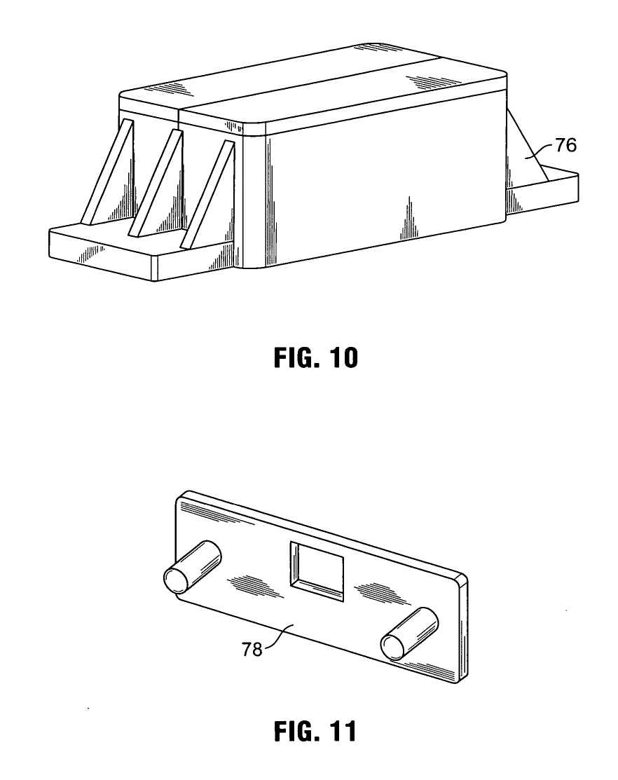

In a yet further embodiment, the rectanguloid plastic part 76 in FIG. 10 is molded with a rectangular cushion or bumper made of a rubber-like material. The bottom, or base, is open, and a molded plastic plate 78 (FIG. 11) with two studs is joined to part 76 by means of either heat staking or ultrasonic welding.

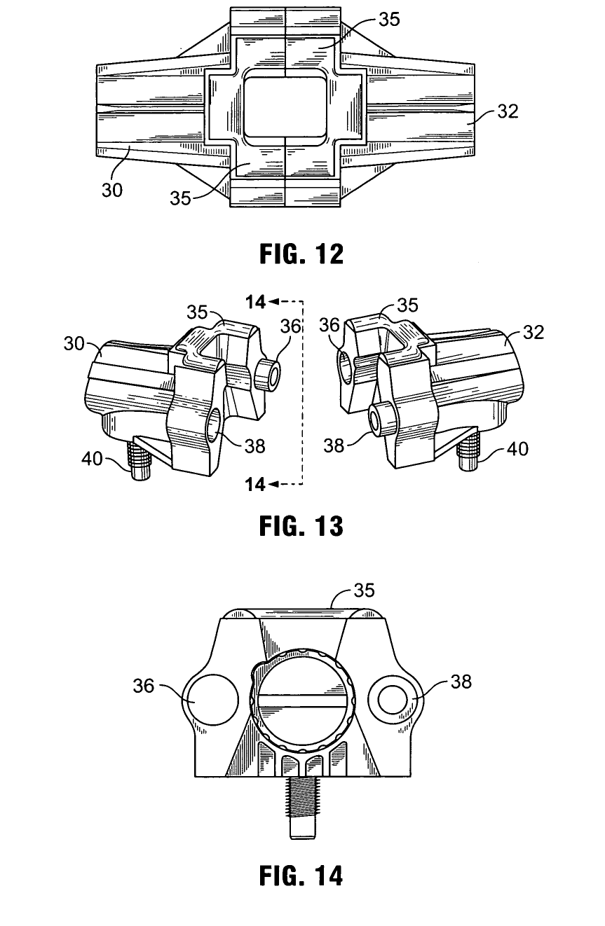

FIGS. 12-14 illustrate another embodiment of the invention. In contrast with the embodiment in FIGS. 2-4, here, the housing parts 30, 32 each have one continuous shaped stop cushion 35 rather than three separate cushions as shown in FIG. 2 and identified by reference numeral 34. Accordingly, the cushions 35 extend along the perimeter of the surface of the housing and around the central aperture, thereby circumscribing it. The footprints, or bases, of cushions 35 can generally resemble the perimeters of the surfaces to which they are attached. Thus, cushions 35 provide added cushioning surface area versus cushions 34, thereby increasing the shock absorbing capability of each housing part 30, 32, and consequently the doorstop as a whole.

Similar to cushions 34, cushions 35 are comprised of elastic material, and joined with the upper surfaces of the housing parts 30 and 32. Of course, other shapes of cushions 35, as well as 34, are readily envisioned.

Having thus described the invention in detail, it is to be understood that the foregoing description is not intended to limit the spirit and scope thereof. What is desired to be protected by Letters Patent is set forth in the appended claims.

1. A doorstop comprising a first housing part and a second housing part;
said first housing part having a first cushion thereon;
said second housing part having a second cushion thereon;
said first cushion having a base that extends along a complete perimeter of a surface to which said first cushion is attached.

2. The doorstop of claim 1, wherein an outline of said base of said first cushion resembles said perimeter of said surface to which said first cushion is attached.

3. The doorstop of claim 1, wherein said first housing part comprises an approximately trapezium shape.

4. The doorstop of claim 3, wherein said first and said second housing parts fit together with an aligning mechanism comprising two cooperative elements.

5. The doorstop of claim 4, further comprising two male protrusions extending in a direction away from said first cushion, and spaced apart in a direction along a longitudinal axis of said doorstop.

6. The doorstop of claim 5, wherein said two male protrusions are threaded.

7. The doorstop of claim 5, wherein said two male protrusions are unthreaded.

8. The doorstop of claim 5, wherein said first and said second housing parts are each formed using a sonic welding process.

9. The doorstop of claim 1, further comprising a central aperture, said first cushion and said second cushion positioned around said central aperture.

10. The doorstop of claim 9, wherein said first and said second cushions, together, circumscribe said central aperture.

11. The doorstop of claim 1, further comprising two male protrusions extending in a direction away from said first cushion, and spaced apart in a direction along a longitudinal axis of said doorstop.

12. A doorstop comprising:
a first housing part of approximately trapezium shape, said first housing part having a first cushion thereon, said first cushion having a base that extends along a complete perimeter of a surface to which said first cushion is attached;
a second housing part of approximately trapezium shape, said second housing part having a second cushion thereon;
said first and said second housing parts cooperatively arranged together to form said doorstop;
said doorstop further comprising an aperture therethrough; and
said first and said second cushions positioned around said aperture.

13. The doorstop of claim 12, wherein an outline of said base of said first cushion resembles said perimeter of said surface to which said first cushion is attached.

14. The doorstop of claim 12, wherein said first and said second cushions, together, circumscribe said aperture.

15. The doorstop of claim 12, wherein said first and said second housing parts fit together with an aligning mechanism comprising two cooperative elements.

16. The doorstop of claim 15, further comprising two male protrusions extending in a direction away from said first cushion, and spaced apart in a direction along a longitudinal axis of said doorstop.

17. The doorstop of claim 16, wherein said two male protrusions are threaded.

18. The doorstop of claim 16, wherein said two male protrusions are unthreaded.

19. The doorstop of claim 16, wherein each of said first and said second housing part is formed using a sonic welding process.

20. The doorstop of claim 12, wherein each of said first and said second housing part is formed using a sonic welding process.
